(19) United States
(12) Patent Application Publication
(10) Pub. No.: US 2018/0143714 A1
(43) Pub. Date: May 24, 2018

(54) DISPLAY SUBSTRATE, FABRICATION METHOD FOR FORMING THE SAME, AND DISPLAY DEVICE CONTAINING THE SAME

(71) Applicants: BOE TECHNOLOGY GROUP CO., LTD, Beijing (CN); BEIJING BOE DISPLAY TECHNOLOGY CO., LTD., Beijing (CN)

(72) Inventors: Qi SANG, Beijing (CN); Baoqiang WANG, Beijing (CN); Sangjin PARK, Beijing (CN)

(21) Appl. No.: 15/509,336

(22) PCT Filed: Sep. 30, 2016
(86) PCT No.: PCT/CN2016/101075

§ 371 Date: Mar. 7, 2017

(30) Foreign Application Priority Data
Jan. 4, 2016 (CN) 201610006872.8

(51) Int. Cl. G06F 3/041; G06F 3/044

(52) U.S. Cl. CPC G06F 3/0412; G06F 2203/04103; G06F 3/044; G06F 3/0416

(57) ABSTRACT

The present application discloses a display substrate, including: a plurality of gate lines, a plurality of data lines, a plurality of gate lead wires, and a plurality of touch electrode lead wires, each one of the plurality of gate lead wires configured for providing a Gate signal to at least one of the plurality of gate lines, at least one of the plurality of touch electrode lead wires configured for transmitting a touch signal to a touch electrode. At least one of the plurality of gate lead wires and at least one of the plurality of touch electrode lead wires being aligned along a direction that one of the plurality of data lines is aligned.

### CROSS-REFERENCE TO RELATED APPLICATION

This application claims priority to Chinese Patent Application No. 201610006872.8, filed Jan. 4, 2016, the contents of which are incorporated by reference in the entirety.

### TECHNICAL FIELD

The present invention relates to display technology, more particularly, to a display substrate, a fabrication method for forming the display substrate, and a display device containing the display substrate.

### BACKGROUND

As technology advances, liquid crystal displays (LCDs), organic light-emitting diode (OLED) displays, and other high-tech displays have been widely used in display devices such as laptop computers, smart phones, and televisions. In-cell touch technology provides one-stop service and becomes a solution to implement display functions with touch functions, By using in-cell technology, touch panels can be integrated with LEDs. In-cell technology has high integration level, low power consumption, high display quality, and multiple touch points. In-cell technology also makes the display device thin and light, and low in cost. Because of these advantages, in-cell technology has become a trench in display technology.

### SUMMARY

In one aspect, the present invention provides a display substrate, including: a plurality of gate lines, a plurality of data lines, a plurality of gate lead wires, and a plurality of touch electrode lead wires, each one of the plurality of gate lead wires configured for providing a gate signal to at least one of the plurality of gate lines, at least one of the plurality of touch electrode lead wires configured for transmitting a touch signal to a touch electrode. At least one of the plurality of gate lead wires and at least one of the plurality of touch electrode lead wires are aligned along a direction that one of the plurality of data lines is aligned.

Optionally, the at least one of the plurality of gate lead wires and the at least one of the plurality of touch electrode lead wires are aligned with one another.

Optionally, the plurality of gate lead wires and the plurality of touch electrode lead wires form a one-to-one correspondence.

Optionally, the at least one of the plurality of gate lead wires, the at least one of the plurality of touch electrode lead wires, and the one of the plurality of data lines are made of a same material.

Optionally, one of the plurality of gate lead wires is connected to a corresponding gate line through a first via.

Optionally, the plurality of gate lead wires is connected to a gate integrated circuit (IC) and the plurality of touch electrode lead wires is connected to a touch IC, the gate IC being located at one side of the plurality of data lines and the touch IC being located at another side of the plurality of data lines.

Optionally, the plurality of data lines is connected to a data IC and the touch IC is integrated in the data IC.

Optionally, one frame includes a display period and a touch-sensing period. In the display period, the plurality of gate lines receives gate signals from the gate IC through the plurality of gate lead wires connected to the gate lines, the plurality of data lines receives data signals from the data IC; and in the touch-sensing period, the touch electrode receives a touch signal from the touch IC through the at least one of the plurality of touch electrode lead wires.

Optionally, display substrate further includes a plurality of pixels arranged in an. array, wherein two columns of pixels are arranged between two data lines, each one of two pixels in one row between the two data lines being connected to a different one of two adjacent gate lines.

Optionally, one of the plurality of gate lead wires and one of the plurality of touch lead wires are aligned with one another and disposed between adjacent two columns of pixels between two data lines.

Another aspect of the present disclosure provides a display device, including one or more of the disclosed display substrates.

Another aspect of the present disclosure provides a fabrication method for forming the display substrate, including: forming a gate conductive layer on a substrate, the gate conductive layer including a plurality of gate lines; and forming a data conductive layer on the substrate, the data conductive layer including a plurality of data lines, a plurality of gate lead wires, and a plurality of touch electrode lead wires, at least one of the plurality of gate lead wires and at least one of the plurality of touch electrode lead wires being along a same direction that one of the plurality of data lines is aligned.

Optionally, the method further includes: forming a gate insulating layer between the gate conductive layer and the data conductive layer.

Optionally, one of the plurality of gate lead wires is connected to one of the plurality of gate lines through a first via.

Optionally, the method further includes: forming a touch electrode layer, the touch electrode layer comprising a plurality of touch electrodes; and forming a planarization layer between the touch electrode layer and the data conductive layer, at least one of the plurality of touch electrode lead wires being connected to one of the plurality of touch electrodes through a second via.

In another aspect, the present invention provides a display apparatus comprising a. touch control display panel described herein.

### BRIEF DESCRIPTION OF THE FIGS.

The following drawings are merely examples for illustrative purposes according to various disclosed embodiments and are not intended to limit the scope of the present invention.

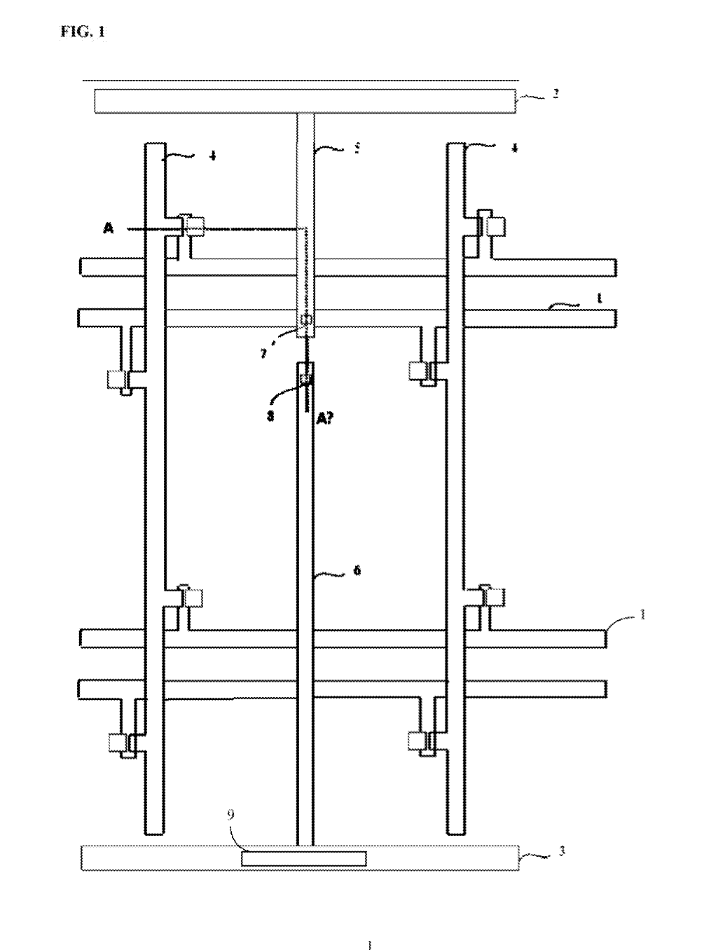

FIG. 1 illustrates an exemplary display substrate according to various disclosed embodiments of the present disclosure;

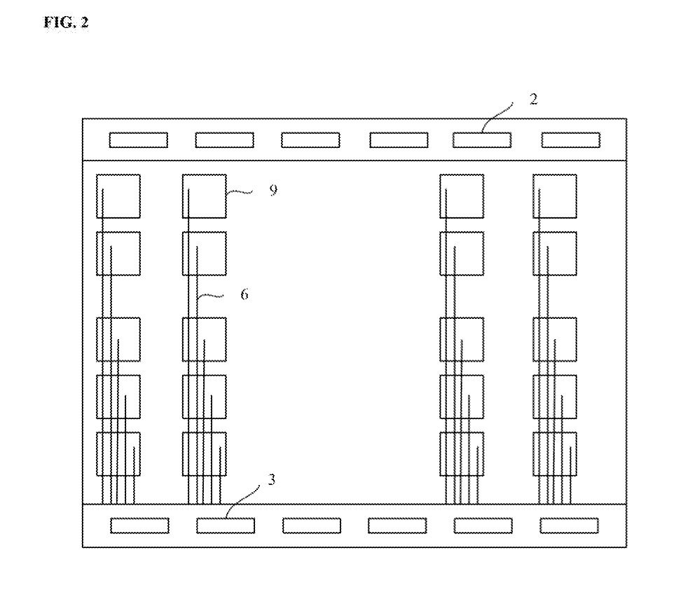

FIG. 2 illustrates another exemplary display substrate according to various disclosed embodiments of the present disclosure;

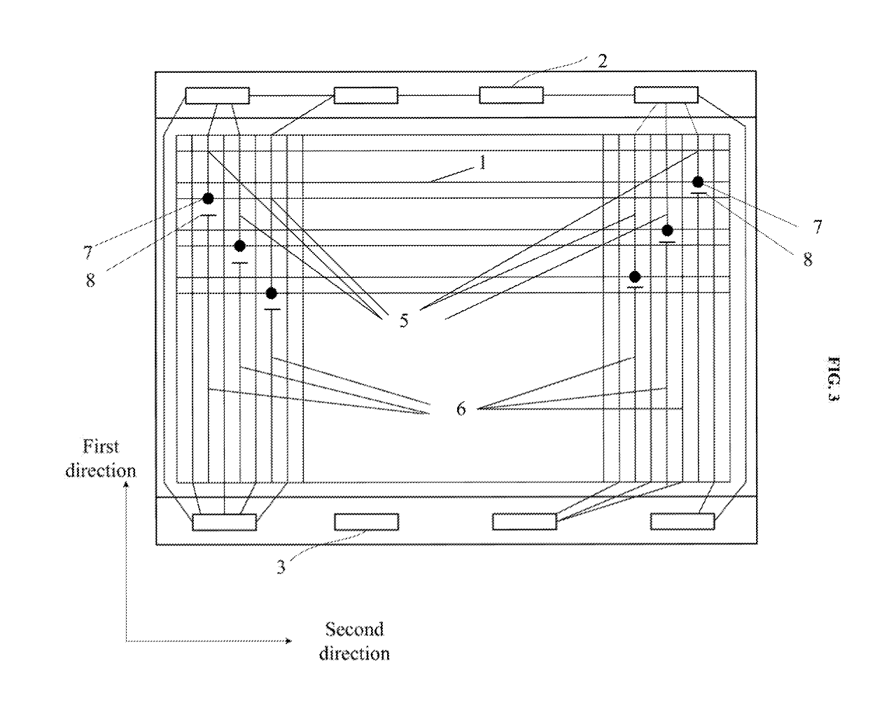

FIG. 3 illustrates another exemplary display substrate according to various disclosed embodiments of the present disclosure:

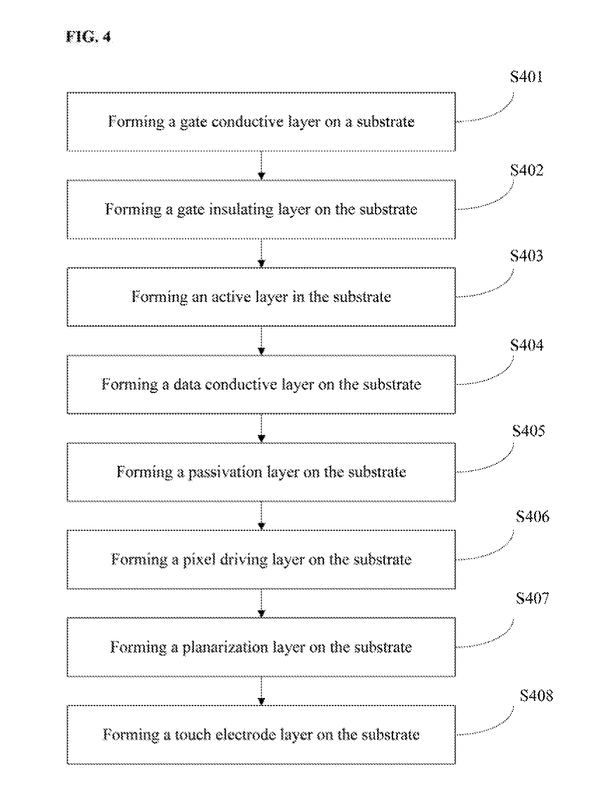

FIG. 4 illustrates an exemplary process for fabricating a display substrate with a bottom-gated structure according, to various disclosed embodiments of the present disclosure;

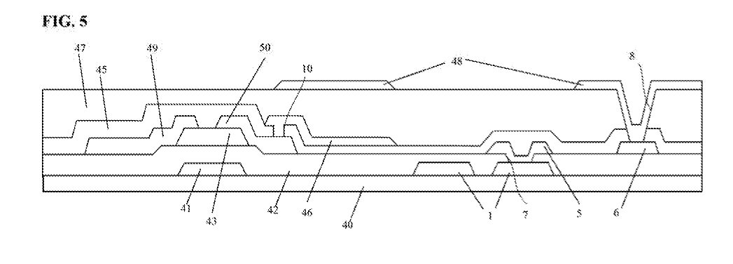

FIG. 5 illustrates a cross-sectional view of an exemplary display substrate according to various disclosed embodiments of the present disclosure;

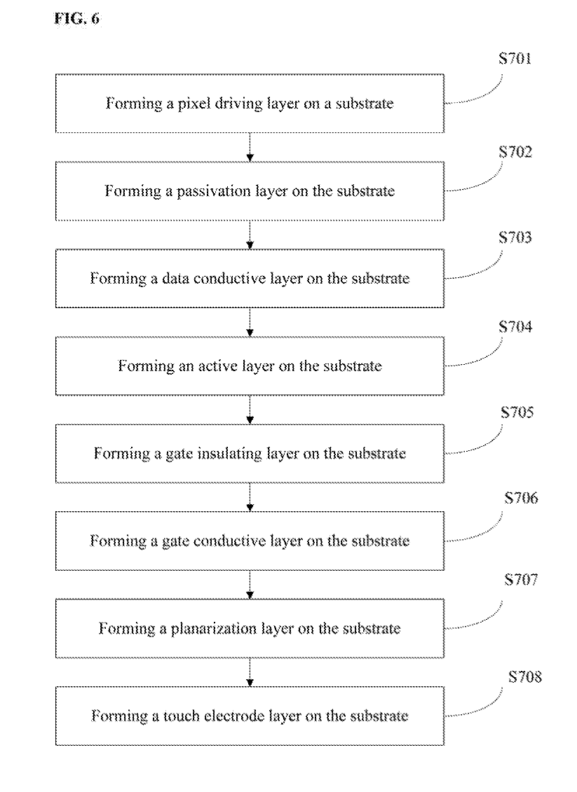

FIG. 6 illustrates an exemplary process for fabricating a display substrate with a. top-gated structure according to various disclosed embodiments of the present disclosure; and

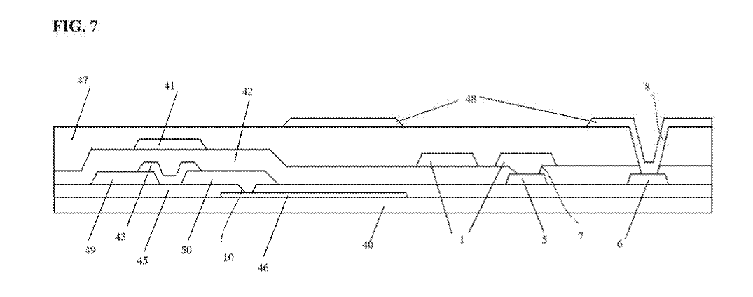

FIG. 7 illustrates a cross-sectional view of another exemplary display substrate according to various disclosed embodiments of the present disclosure.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

For illustrative purposes, terms “intersect” and “intersection” are used to describe the positions of two or more lines not being parallel to each other, and do not infer any physical or electrical connection between any lines. One line being intersecting with another line refers to that the two lines are not disposed to be parallel to each other. The orthogonal projection of one line on the display substrate and the orthogonal projection of the other line on the display substrate may intersect.

In many instances, the display products with in-cell touch functions include two independent address scanning routes. One address scanning route often includes touch transmission lines and touch sensing lines to facilitate touch functions. The other address scanning route often includes gate lines and data lines to facilitate display functions. The two independent address scanning routes may result in relatively wide bezel in the in-cell touch products. In addition, when the gate lines and the data lines intersect with the touch transmission lines and touch sensing lines, display signals may interfere with touch signals. Touch functions and display functions of the display device may be impaired.

Embodiments consistent with the present disclosure provide a display substrate. Capacitive in-cell touch technology is applied in the pixels of the display substrate. Time-sharing driving methods may be applied to drive the display substrate. The display period and the touch-sensing period may be separated to prevent signal interference.

A display substrate, comprising: a plurality of gate lines, a plurality of data lines, a plurality of gate lead wires, and a plurality of touch electrode lead wires, each one of the plurality of gate lead wires configured for providing a gate signal to at least one of the plurality of gate lines, at least one of the plurality of touch electrode lead wires configured for transmitting a touch signal to a touch electrode, wherein at least one of the plurality of gate lead wires and at least one of the plurality of touch electrode lead wires are aligned along a direction that one of the plurality of data lines is aligned. In some embodiments, the at least one of the plurality of gate lead wires and the at least one of the plurality of touch electrode lead wires are aligned with one another.

FIG. 1 illustrates a top view of an exemplary display substrate. As Shown in FIG. 1, the display substrate may include a gate line 1, a gate integrated circuit (IC) 2, a data IC 3, a touch IC 9, and a data line 4. The gate line 1 and the data line 4 may be perpendicular to each other. One or more gate lines 1 may be included in the display substrate, and one or more data lines 4 may be included in the display substrate. In one embodiment, the touch IC 9 may be integrated in the data IC 3. In various other embodiments, the touch IC may not be integrated in the data IC. In some embodiments, two pixels in one row of pixels may be connected to and controlled by the two adjacent gate lines 1 disposed above and below the row of pixels (e.g., the two gate lines 1 labeled in FIG. 1). Two columns of pixels may be disposed between two adjacent data lines 4 (e.g., the two data lines 4 labeled in FIG. 1) on the left side and the on the right side of the two columns of pixels. Each one of the two pixels in one row, between the two data lines 4, may be connected to a different one of the adjacent gate lines 1, one gate line being above the two pixels and the other gate line being below the two pixels. The above arrangement of the gate lines may be referred to as a dual-gate design.

FIG. 2 illustrates a top view of another exemplary display substrate. As shown in FIG. 2, in the display substrate, the gate IC 2 and the data IC 3 may be disposed to be opposing each other, where the touch IC may be integrated in the data IC 3. In FIGS. 1 and the gate IC 2 and the data IC 3 may he disposed at two sides of a data line 4. The touch IC may be arranged at the same side with the data IC 3. The display substrate may include an array of M by N touch electrodes 9. The touch electrodes 9 may be configured to receive touch signals in a touch period in a frame, and may be used as common electrodes to receive driving signals in a display period in a frame. Each touch electrode 9 may be connected to the touch IC through a touch electrode lead wire 6.

The disclosed display substrate may also include a gate lead wire 5. The gate lead wire 5 may transmit a gate signal to at least one gate lines 1. The gate lead wire 5 and the touch electrode lead wire 6 may be formed through a same fabrication step. As shown in FIG. 1, a touch electrode lead wire 6 may correspond to a gate lead wire 5. The gate lead wires 5 and the touch electrode lead wires 6 may be disposed between the gate IC 2, and the data IC 3. The gate lead wires 5 may be disposed to be on the side that is closer to the gate IC 2, and the touch electrode lead wires 6 may be disposed to be on the side that is closer to the data IC 3. A touch electrode lead wire 6 may transmit a touch signal to a touch electrode. In some embodiments, at least one gate lead wire 5, at least one touch electrode lead wire 6, and the data lines 4 may be made of a same material through a same fabrication step.

In some embodiments, a gate lead wire 5 may be disposed on one side of the data lines 4. In some other embodiments, the gate lead wire 5 may be disposed between two adjacent data lines 4. In some embodiments, the touch electrode lead wire 6 may be disposed on one side of the data lines 4. In some other embodiments, the touch electrode lead wire 6 may be disposed between two adjacent data lines 4. In one embodiment, the gate lead wire 5 and the touch electrode lead wire 6 may be disposed between two adjacent data lines 4 for the dual gate design. By applying dual gate design, less data lines 4 may be used in the display substrate. Accordingly, the number of connection points between the data lines 4 and the data IC 3 may be reduced. The fabricated display substrate may be less costly.

In some embodiments, a gate lead wire 5 may be used to connect a corresponding gate line 1 with the gate IC 2. A gate lead wire 5 may be configured to control the on (connected) and off (disconnected) states of the corresponding gate line 1. When the gate lines 1 are turned on, the display substrate may be turned on to perform display functions.

As shown in FIG. 3, the gate lead wires 5 may connect the gate lines 1 with the gate IC 2. A black dot may represent the connection point between a gate line 1 and a gate lead wire 5. At least one gate lead wires 5 may be disposed from the gate IC 2 to the connection points with the gate lines 1, along the same direction the data lines 4 are aligned.

As shown in FIG. 3, touch electrode lead wires 6 may be connected to the touch IC integrated in the data IC 3. At least one touch electrode lead wires 6 may be disposed along the same direction the data lines 4 are aligned. A touch electrode lead wire 6 may be arranged to be separated from the connection point between a gate lead wire 5 and a gate line 1 by a certain distance, such that the touch electrode lead wires 6 and the gate lead wires 5 may be insulated from each other. The certain distance between a gate lead wire 5 and a touch electrode lead wire 6 may be any suitable value, e.g., about 1 cm and about 0.5 cm. By disposing the touch electrode lead wires 6 to be separated from the gate lead wires 5, narrow bezel of the display substrate may be easier to implement.

Referring to FIG. 1, the display substrate may also include a first via 7, in some embodiments, a gate line 1 and a corresponding gate lead wire 5 may be connected through the first via 7. The gate line 1 may be connected to the gate IC 2 through the gate lead wire 5. Thus, the gate line 1 may be turned on and off to implement switching functions, i.e., to turn on and off the display substrate. The display substrate may implement normal display functions.

As shown in FIGS. 1 and 2, the display substrate may further include a second via 8. At least one touch electrode lead wire 6 may be connected to a touch electrode 9 through the second via 8. The touch electrode 9 may be connected to the data IC 3 through the touch electrode lead wire 6 such that the touch electrode 9 may receive touch signals from the touch IC through the touch electrode lead wire 6 and proper touch functions may be implemented. One touch electrode 9 may be connected with or may correspond to one or more touch electrode lead wires 6. The touch electrode lead wires 6 corresponding to the same touch electrode 9 may transmit same touch signals. One touch electrode lead wire 6 may be connected with at least one touch electrode 9. In one embodiment, the touch electrodes 9 and the touch electrode lead wires 6 may form a one-to-one correspondence, as shown in FIG. 2. In this case, one gate lead wire 5 may correspond to one touch electrode lead wire 6, and the gate lead wire 5 may be aligned with the touch electrode lead wire 6 along the direction the data lines 4 are arranged. In one embodiment, the gate lead wires and the touch electrode lead wires may form a one-to-one correspondence.

For illustrative purposes, FIG. 1 only shows one structural unit of the display substrate. In practice, the display substrate may include a plurality of the structural units shown in FIG. 1. Details of other same structural units are not described herein.

Referring to FIGS. 1 and 3, the gate lines 1 may be arranged along a first direction between gate IC 2 and the data IC 3. The locations of the first vias 7, for connecting the gate lines 1 and the gate lead wires 5 and indicated as the black dots in FIG. 3, may have an ascending step-like shape along a second direction, or may have a descending step-like shape along the second direction. The locations of the second vias 8, for connecting the touch electrode lead wires 6 and the touch electrodes 9 and indicated as the short dashes in FIG. 3, may also have an ascending step-like shape along the second direction, or may have a descending step-like shape along the second direction. The arrangement of the second vias 8 may be designed according to the arrangement of the first vias 7. In some embodiments, the arrangement of the first vias 7 and the arrangement of the second via s 8 may be the same or similar. In some embodiments, the first direction may be parallel to the direction the data lines 4 are aligned, and the second direction may be parallel to the direction the gate lines 1 are aligned.

The present disclosure provides a display substrate. In the disclosed display substrate, a gate lead wire and the corresponding touch electrode lead wire may be arranged to be separated from each other. Thus, interference between the signals transmitted by the gate lead wire and the corresponding touch electrode lead wire may be prevented. Display effect and touch effect of the display substrate may be improved. The gate lead wires and the touch electrode lead wires may not be arranged throughout the entire display substrate so that less space may be used for wiring. The display device containing the display substrate may have narrow bezel.

The display substrate may be operated under a time-sharing mode. In operation, each operating period, e.g., a frame, may include at least a display period and at least a touch-sensing period.

As shown in FIGS. 2 and 3, in a display period, the gate IC 2 may sequentially send a turn-on signal or a gate signal through each gate lead wire S to turn on or scan the gate line 1 connected to the gate lead wire 5. The gate lines may be scanned according to a desired gate line scanning sequence such that pixels may be turned on sequentially. Meanwhile, the data IC 3 may sequentially send a data signal through each data line 4 according to the same gate line scanning sequence so that desired pixel data may be sent to the pixels. The touch electrodes 9 may be used as common electrodes in the display period. Thus, the disclosed display substrate may implement proper display functions.

In a touch-sensing period, as shown in FIG. 2, the touch IC may sequentially receive touch-sensing signals from the touch electrodes 9 through each touch electrode lead wire 6 for configuring touch motions. Columns of touch electrodes 9 may be scanned according to a desired touch scanning sequence. If a touch motion is performed on the display substrate, the touch IC may receive touch sensing signals through the touch electrode lead wires 6 reflecting the capacitance change at the touch location. The touch IC may detect the touch motion and respond accordingly. Thus, the disclosed display substrate may implement proper touch functions.

The above-mentioned technical solutions may be combined in any suitable way to generate various embodiments of the present disclosure. Details of the combination are not repeated herein.

Another aspect of the present disclosure provides a display device. The display device may include one or more of the, disclosed display substrates. The disclosed display substrate may be any one of the display substrate illustrated in FIGS. 1-3. In practice, the display device may be a smart phone, a tablet computer, a smart television, a laptop computer, a digital photo frame, a navigation device, or any other suitable products or parts with display functions.

In the disclosed display device, a gate lead wire and the corresponding touch electrode lead wire may be arranged to be separated from each other. Thus, interference between the signals transmitted by the gate lead wire and the corresponding touch electrode lead wire may be prevented. Display effect and touch effect of the display substrate may be improved. The gate lead wires and the touch electrode lead wires may not be arranged throughout the entire display substrate so that less space may be used for wiring. The display device containing the display substrate may have a narrow bezel.

The disclosed display substrate may have a bottom-gated structure or a top-gated structure. The fabrication processes of the display substrate with a bottom-gated structure and with a top-gate structure are now described in detail.

Another aspect of the present disclosure provides a fabrication method for forming a display substrate with a bottom-gated structure. An exemplary process flow of the fabrication method may be illustrated in FIG. 4. FIG. 5 illustrates a cross-sectional view of the display substrate along the AA′ direction shown in FIG. 1. The film structure of the display substrate may be shown in FIG. 5. The fabrication method may include steps S401-S408.

In step S401, a gate conductive layer may be thou on a substrate. Step S401 may further include steps S4011-S4013 (not shown).

In step S4011, the substrate 40 may be properly cleaned to prepare for the subsequent fabrication steps.

In step S4012, a deposition method may be used to form a gate conductive film on the substrate 40. In one embodiment, sputtering may be used to form the gate conductive film.

The gate conductive film may be a metal film made in one or more of Al, Cr, W, Ti, Ta, Mo, and Cu. The gate conductive film may also be a metal film made in at least two of Al, Cr, W, Ti, Ta, Mo, and Cu. The gate conductive film may also be a multiple-layered films, made of a plurality of different metals. The thickness of the gate conductive film may be between about 200 to about 1000 nm.

In step S4013, a patterning process may be used to form the gate conductive layer on the substrate 40. In some embodiments, the patterning process may include a photolithography process and a suitable etching process.

The photolithography process may be used to define the pattern of the gate conductive layer on the substrate 40. A wet etching process may be performed on the substrate 40. Further, the photoresist layer may be removed. The gate conductive layer may be formed on the substrate 40. The gate conductive layer may include a gate line 1 and a gate electrode 41.

In step S402, a gate insulating layer 42 may be formed the substrate 40 to cover the gate conductive layer.

A deposition process may be used to form the gate insulating layer 42. In some embodiments, plasma enhanced chemical vapor deposition (PECVD) may be used to form a gate insulating film on the gate conductive layer. The gate insulating film may be a single-layered structure or a multiple-layered structure. The gate insulating film may be made of one or more of SiO₂, Si₃N₄, amd SiOₓN_{y}. The thickness of the gate insulating film may be about 5 to about 300 nm. Further, a suitable patterning process may be used to form the first vias 7 in the gate insulating film. The gate insulating film with the first vias 7 may be referred as the gate insulating layer 42. In some embodiments, the patterning process may include a photolithography process and a suitable etching process.

In step S403, an active layer 43 may be formed on the substrate 40.

A deposition process, e.g., sputtering, may be used to form an active film on the gate insulating layer 42. In some embodiments, the active film may be made of one or more of IGZO, ZnO, ZnON, ITZO, and other suitable oxide materials. The active film may be a monobasic or multibasic oxide material. The thickness of the active film may be about 5 to about 250 nm. A patterning process may be used to define the pattern of the active layer from the active film. In some embodiments, the patterning process may include a photolithography process and a suitable etching process. For example, a wet etching process may be used to etch desired regions of the active film. Further, the photoresist may be removed. The active layer 43 may be formed on the gate insulating layer 42.

In step S404, a data conductive layer may he formed on the substrate 40.

The data, conductive layer may include a data line (not shown in FIG. 5), a gate lead wire 5, a touch electrode lead wire 6, a source electrode 49, and a drain electrode 50. The gate lead wire 5 and the touch electrode lead wire 6 may be aligned along'the direction the data fine is arranged. Step S404 may include steps S4041-S4045 (not shown).

In step S4041, a source and drain metal film may be formed on the substrate 40 through a suitable deposition process.

In step S4042, a photoresist layer may be coated on the source and drain metal film.

In step S4043, a mask may be used for exposing the photoresist layer.

In step S4044, the exposed photoresist layer may be developed.

In step S4045, an etching process may be performed on the developed photoresist layer to form the data conductive layer. The gate lead wire 5 may be connected to a gate line 1 through a first via 7,

In step S405, a passivation layer 45 may be formed on the substrate 40,

A suitable deposition process may be used to form the passivation material film, ln some embodiments, PECVD may be used to form the passivation material film, A patterning process may be used to define the pattern of a third via 10. The patterning process may include a photolithography process and an etching process. In some embodiments, a dry etching, process may be performed on the passivation material film to form the third via 10, and the passivation layer 45 may be formed.

In step S406, a pixel driving layer 46 may be formed on the substrate 40.

An indium tin oxide (ITO) film may be deposited on the substrate 40. A patterning process may be performed forth the pixel driving layer 46. The pixel driving layer 46 may be connected to the drain electrode 50 through the third via 10.

In step S407, a planarization layer 47 may be formed on the substrate 40.

A suitable deposition process may be performed to deposit a planarization material film on the substrate 40. In some embodiments, PECVD may be used to form the planarization material film. The planarization film may be made of an inorganic material. A patterning process may be used to define the pattern of the second via 8. The patterning process may include a photolithography process and an etching process. In some embodiments, a dry etching process may be used to etch the planarization material film. Further, the photoresist layer may be removed to form the planarization layer 47. The second via 8 may sequentially pass through the planarization layer 47 and the passivation layer 45 to contact the touch electrode lead wire 6.

In step S408, a touch electrode layer 48 may be formed on the substrate 40.

An ITO film may be formed on the substrate 40. A suitable patterning process may be used to form the touch electrode layer 48. The touch electrode layer 48 may include a plurality of touch electrodes 9. A touch electrode 9 may be connected to a touch electrode lead wire 6 through a second via 8.

In the display substrate formed through the described process, the gate conductive layer may include the gate line, the data conductive layer may include the data line, the gate lead wire, and the touch electrode lead wire. Further, the touch electrode layer may include a plurality of touch electrodes. The gate insulating layer may include the first via, The gate lead wire and the gate line may be connected through the first via. The second via may be formed on the touch electrode lead wire such that the touch electrode and the touch electrode lead wire may form a one-to-one correspondence through the second via.

In the disclosed fabrication method, a gate lead wire and the touch electrode lead wire under the gate lead wire may be arranged to be separated from each other. Thus, interference between the signals transmitted by the gate lead wire and the corresponding touch electrode lead wire may be prevented. Display effect and touch effect of the display substrate may be improved. The gate lead wires and the touch electrode lead wires may not be arranged throughout the entire display substrate so that less space may be used for wiring. The display device containing the display substrate may have narrow bezel.

The present disclosure also provides a display substrate with a top-gated structure. FIG. 6 illustrates an exemplary process flow to fabricate the display substrate with a top-gated structure. FIG. 7 illustrates a cross-sectional view of the display substrate fabricated through the disclosed fabrication method. The cross-sectional view of the display substrate shown in FIG. 7 may be substantially along the same direction as in FIG. 5.

In step S701, a pixel driving layer 46 may be formed on a substrate 40.

In some embodiments, an ITO film may be formed on the substrate 40. A patterning process may be performed to form the pixel driving layer 46.

In step S702, a passivation layer 45 may be formed on the substrate 40.

In some embodiments, a suitable deposition process may be used to form a passivation material film. In some embodiments, PECVD may be used to form the passivation material film. A patterning process, e.g., including a photolithography process and an etching process, may be used to form the passivation layer 45. In some embodiments, a photolithography process may be used to define a third via 10. A dry etching process may be performed to form the third via 10 and the photoresist may be removed. The passivation layer 45 may be formed.

In step S703, a data conductive layer may be formed on the substrate 40.

The data conductive layer may include a source electrode 49, a drain electrode, a gate lead wire 5, and a touch electrode lead wire 6. The process to form the data conductive layer may include steps S7031-S7035 (not shown).

In step S7031, a source and drain metal film may be formed on the substrate 40, through a suitable deposition method.

In step S7032, a photoresist layer may be coated on the source and drain metal film.

In step S7033, a mask may be used to expose the photoresist layer on the substrate 40.

In step S7034, the exposed photoresist layer may be developed.

In step S7035, an etching process may be performed on the substrate 40 after the development to form the data conductive layer. The drain electrode 50 may be connected to the pixel driving layer 46 through the third via 10.

In step S704, an active layer 43 may be formed on the substrate 40.

A deposition process, e.g., sputtering, may be used to form an active film on substrate 40. In some embodiments, the active film may be made of one or more of IGZO, ZnO, ZnON, ITZO, and other suitable oxide materials. The active film may be a monobasic or multibasic oxide material. The thickness of the active film may be about 5 to about 250 nm. A patterning process may be used to define the pattern of the active layer from the active film. In some embodiments, the patterning process may include a photolithography process and a suitable etching process. For example, a wet etching process may be used to etch desired regions of the active film. Further, the photoresist may be removed. The active layer 43 may be thrilled on the substrate 40.

In step S705, a gate insulating layer 42 may be formed on the substrate 40.

A suitable deposition process may be used to form the gate insulating layer 42. In some embodiments, plasma enhanced chemical vapor deposition (PECVD) may be used to form a gate insulating film on the gate conductive layer on the active layer 43. The gate insulating film may be a single-layered structure or a multiple-layered structure. The gate insulating film may be made of one or more of SiO₂, Si₃N₄, and SiOₓN_{y}. The thickness of the gate insulating film may be about 5 to about 300 nm. Further, a suitable patterning process may be used to thrill the first vias 7 in the gate insulating film. The gate insulating film with the first vias 7 may be referred as the gate insulating layer 42. In some embodiments, the patterning process may include a photolithography process and a suitable etching process.

In step S706, a gate conductive layer may be formed on the substrate 40.

A photolithography process may be used to define the pattern of the gate conductive layer on the substrate 40. A wet etching process may be performed on the substrate 40. Further, the photoresist layer may be removed. The gate conductive layer may be formed on the substrate 40. The gate conductive layer may include a gate line 1 and a gate electrode 41.

In step S707, a planarization layer 47 may be formed on the substrate 40.

A deposition process may be performed to deposit a planarization material film on the substrate 40. In some embodiments, PECVD may be used to form the planarization material film. The planarization film may be made of an inorganic material. A patterning process may be used to define the pattern of the second via 8. The patterning process may include a photolithography process and an etching process. In some embodiments, a dry etching process may be used to etch the planarization material film. Further, the photoresist layer may be removed to form the planarization layer 47. The second via 8 may sequentially pass through the planarization layer 47 and the gate insulating layer 42 to contact the touch electrode lead wire 6.

In step S708, a touch electrode layer 48 may be formed in the substrate 40.

An ITO film may be formed on the substrate 40. A suitable patterning process may be used to form the touch electrode layer 48. The touch electrode layer 48 may include a plurality of touch electrodes 9. A touch electrode 9 may be connected to a touch electrode lead wire 6 through a second via 8.

In the display substrate formed through the described process, the gate conductive layer may include the gate line, the data conductive layer may include the data line, the gate lead wire, and the touch electrode lead wire. Further, the touch electrode layer may include a plurality of touch electrodes. The gate insulating layer may include the first via. The gate lead wire and the gate line may be connected through the first via. The second via may be formed on the touch electrode lead wire such that the touch electrode and the touch electrode lead wire may them a one-to-one correspondence through the second via.

In the disclosed fabrication method, a gate lead wire and the touch electrode lead wire under the gate lead wire may be arranged to be separated from each other. Thus, interference between the signals transmitted by the gate lead wire and the corresponding touch electrode lead wire may be prevented. Display effect and touch effect of the display substrate may be improved. The gate lead wires and the touch electrode lead wires may not be arranged throughout the entire display substrate so that less space may be used for wiring. The display device containing the display substrate may have a narrow bezel.

Those skilled in the art should understand that, at least part of the processes described in the embodiments may be implemented through hardware author related software. The computer programs to execute commands may be stored in a readable computer medium. The readable computer medium may be a read-only storage device, a hard disc, and/or an optical disc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1-15. (canceled)

16. A display substrate, comprising: a plurality of gate lines, a plurality of data lines, a plurality of gate lead wires, and a plurality of touch electrode lead wires, each one of the plurality of gate lead wires configured for providing a gate signal to at least one of the plurality of gate lines, at least one of the plurality of touch electrode lead wires configured for transmitting a touch signal to a touch electrode, wherein:
at least one of the plurality of gate lead wires and at least one of the plurality of touch electrode lead wires are aligned along a direction that one of the plurality of data lines is aligned.

17. The display substrate according to claim 16, wherein the at least one of the plurality of gate lead wires and the at least one of the plurality of touch electrode lead wires are aligned with one another,

18. The display substrate according to claim 17, wherein the plurality of gate lead wires and the plurality of touch electrode lead wires form a one-to-one correspondence.

19. The display substrate according to claim 16, wherein the at least one of the plurality of gate lead wires, the at least one of the plurality of touch electrode lead wires, and the one of the plurality of data lines are made of a same material.

20. The display substrate according to claim 16, wherein one of the plurality of gate lead wires is connected to a corresponding gate line through a first via.

21. The display substrate according to claim 17, wherein the plurality of gate lead wires is connected to a gate integrated circuit (IC) and the plurality of touch electrode lead wires is connected to a touch IC, the gate IC being located at one side of the plurality of data lines and the touch IC being located at another side of the plurality of data lines.

22. The display substrate according to claim 21, wherein the plurality of data lines is connected to a data IC and the touch IC is integrated in the data IC.

23. The display substrate according to claim 22, one frame comprising a display period and a touch-sensing period, wherein in the display period, the plurality of gate lines receives gate signals from the gate IC through the plurality of gate lead wires connected to the gate lines, the plurality of data lines receives data signals from the data IC; and in the touch-sensing, period, the touch electrode receives a touch signal from the touch IC through the at least one of the plurality of touch electrode lead wires.

24. The display substrate according to claim 16, further comprising a plurality of pixels arranged in an array, wherein two columns of pixels are arranged between two data lines, each one of two pixels in one row between the two data lines being connected to a different one of two adjacent gate lines.

25. The display substrate according to claim 24, wherein one of the plurality of gate lead wires and one of the plurality of touch lead wires is aligned with one another and disposed between adjacent two columns of pixels between two data lines.

26. A display device, comprising one or more of the display substrates according to claim 16.

27. A fabrication method for forming the display substrate, comprising:
forming a gate conductive layer on a substrate, the gate conductive layer including a plurality of gate lines; and
forming a data conductive layer on the substrate, the data conductive layer including a plurality of data lines, a plurality of gate lead wires, and a plurality of touch electrode lead wires, at least one of the plurality of gate lead wires and at least one of the plurality of touch electrode lead wires being along a same direction that one of the plurality of data lines is aligned.

28. The method according to claim 27, further comprising:
forming a gate insulating layer between the gate conductive layer and the data conductive layer.

29. The method according to claim 28, wherein one of the plurality of gate lead wires is connected to one of the plurality of gate lines through a first via.

30. The method according to claim 27, further comprising:
forming a touch electrode layer, the touch electrode layer comprising a plurality of touch electrodes; and
forming a planarization layer between the touch electrode layer and the data conductive layer, at least one of the plurality of touch electrode lead wires being connected to one of the plurality of touch electrodes through a second via.
